(19) United States
(12) Patent Application Publication
(10) Pub. No.: US 2018/0081367 A1
(43) Pub. Date: Mar. 22, 2018

(54) METHOD AND SYSTEM FOR AUTOMATICALLY CHARGING ROBOT

(71) Applicant: Nanjing AvatarMind Robot Technology Co., Ltd., Nanjing (CN)

(72) Inventors: Tingliang LI, Nanjing (CN); Zhen LI, Nanjing (CN)

(21) Appl. No.: 15/806,286

(22) Filed: Nov. 7, 2017

Related U.S. Application Data
(63) Continuation of application No. PCT/CN2017/098794, filed on Aug. 24, 2017.

(30) Foreign Application Priority Data
Sep. 8, 2016 (CN) 201610812719.4

(51) Int. Cl. G05D 1/02; B60L 11/18; B25J 19/00; G05D 1/00

(52) U.S. Cl. CPC G05D 1/0225; B60L 11/1861; B25J 19/005; B60L 2230/16; G05D 1/0022; B60L 11/1824; Y10S 901/01; G05D 1/0255

(57) ABSTRACT

The present disclosure discloses a method and system for automatically charging a robot. The method includes: detecting, by the robot, a battery level, and communicating with a charging mount in a wireless manner if the battery level is less than a predetermined threshold; calculating, by the robot, a distance and angle of the robot relative to the charging mount according to a process that the robot communicates with the charging mount in the wireless manner; controlling, by a motion control system of the robot, the robot to approach the charging mount according to the distance and angle; and interconnecting, by the robot, with the charging mount for charging when the robot moves to the front of the charging mount or the distance and angle are less than predetermined thresholds.

This application is a continuation application of the international patent application PCT/CN2017/098794, filed on Aug. 24, 2017, which is based upon and claims priority of Chinese Patent Application No. 201610812719.4, filed before Chinese Patent Office on Sep. 8, 2016 and entitled “METHOD AND SYSTEM FOR AUTOMATICALLY CHARGING ROBOT”, the entire contents of which are incorporated herein by reference.

### TECHNICAL FIELD

The present disclosure relates to the field of robot-assistant technologies, and in particular, relates to a method and system for automatically charging a robot.

### BACKGROUND

Two methods for automatically charging a robot are currently available. In one method, a charging mount guides a robot to trace to the charging mount, the charging mount is configured with a signal transmitter, and the robot is configured with a signal receiver. The generally-used method is infrared ranging-based positioning, but this method may cause defects. Since infrared signals are transmitted and received in a point-to-point mode, an infrared transmitter and an infrared receiver need to be arranged in the same horizontal plane. It is hard to implement infrared positioning in a complicated uneven application environment. In addition, dust fragments may cause interference to receiving of the infrared ray on the robot, and the infrared ray is simply subject to interference caused by an indoor fluorescent lamp during the transmission course thereof. In the other method, by using laser modeling or camera identification, the robot positions the charger, and in combination of a motion control system of the robot, the robot is enabled to automatically move to the charging mount, such that the robot is automatically charged. However, the implementation of this solution is very difficult, and the cost is high.

### SUMMARY

The problem to be solved in the present disclosure is to provide a method and system for automatically charging a robot. The method and system have a low implementation cost, and are suitable for a complicated environment.

To achieve the above objectives, the present disclosure employs the following technical solutions:

A method for automatically charging a robot includes the following steps:

detecting, by the robot, a battery level, and communicating with a charging mount in a wireless manner if the battery level is low;

calculating, by the robot, a distance and angle of the robot relative to the charging mount according to a process that the robot communicates with the charging mount in the wireless manner;

controlling, by a motion control system of the robot, the robot to approach the charging mount according to the distance and angle; and

interconnecting, by the robot, with the charging mount for charging when the robot moves to the front of the charging mount or the distance and angle are less than predetermined thresholds.

Further, the process that the robot communicates with the charging mount in the wireless manner is implemented by: receiving, by the robot, a wireless synchronization signal sent by a wireless communication module of the charging mount by using a wireless communication module configured on the robot; and receiving, by the robot, an ultrasonic pulse signal sent by an ultrasonic transmitting module by using a first ultrasonic receiving module and a second ultrasonic receiving module that are configured on the robot; wherein the wireless synchronization signal and the ultrasonic pulse signal are simultaneously sent.

Furthermore, in the course of receiving the ultrasonic pulse signal sent by the ultrasonic transmitting module on the charging mount by the robot, if the robot rotates in place by 180 degrees but still fails to receive the ultrasonic pulse signal sent by the ultrasonic transmitting module on the charging mount, the robot starts wall movement (avoiding obstacles) in a clockwise direction.

Further, the robot calculates the distance and angle of the robot relative to the charging mount according to the time when the ultrasonic pulse signal is received by the first ultrasonic receiving module, the time when the ultrasonic pulse signal is received by the second ultrasonic receiving module, a time difference between the time when the ultrasonic pulse signal is received by the first ultrasonic receiving module and the time when the ultrasonic pulse signal is received by the second ultrasonic receiving module.

Furthermore, the process that the robot calculates the distance and angle of the robot relative to the charging mount is specifically as follows: at the time of T0, the charging mount simultaneously sends the wireless synchronization signal and the ultrasonic pulse signal. Since the wireless signal is propagated at light velocity in the air and the light velocity is far greater than the propagation velocity of the ultrasonic wave in the air, at the time of T1, the robot firstly receives the wireless synchronization signal. At the time of T2 and T3, the first ultrasonic receiving module and the second ultrasonic receiving module of the robot respectively receive the ultrasonic pulse signal sent by the charging mount. Assume that the propagation velocity of the ultrasonic wave in the air under room temperatures is 340 m/s, a distance between the charging mount and one ultrasonic receiver and a distance between the charging mount and another ultrasonic receiver are respectively L1=340*(T3−T1+T1−T0) and L2=340*(T2−T1+T1−T0). Since the propagation time T1−T0 of the wireless signal is too short and may be even ignored, the distance between the charging mount and one ultrasonic receiver and the distance between the charging mount and the other ultrasonic receiver may be respectively simplified to L1=340*(T3−T1), and L2=340*(T2−T1). As such, L1 and L2 are calculated, and since the triangles L1 and L2 are known, L3+L4 is also fixed, a vertical distance L5 between the charging mount and the robot and an angle deviation (−) of the charging mount relative to the robot may be calculated using the following formulae:

L2²=L1²+(L3+L4)²−2*L1*(L3+L4)*cos(θ)

cos(θ)=L3/L1

L1²=L5²+L3²

cos(α)=L5/L1

cos(δ)=L5/L2

In this way, a position of the robot may be precisely positioned, and the robot is navigated to go back to the charging mount for charging.

A system for automatically charging a robot includes: a robot control system, a robot power management system, a robot motion control system, a robot positioning and ultrasonic distance and angle calculation control panel, a first ultrasonic receiving module 1, a second ultrasonic receiving module 2, and a charging power source and ultrasonic positioning management system, an ultrasonic transmitting module 3 and a wireless communication module that are configured on a charging mount.

Further, the system for automatically charging a robot further includes: a charging management unit, a battery voltage and current sampling unit and a battery unit.

Further, the system for automatically charging a robot further includes: a servo motor control unit and a robot chassis motor speed and angle sampling unit.

In the method and system for automatically charging a robot according to the present disclosure, by configuring an ultrasonic transmitting module and a wireless communication module on a charging mount, and configuring two ultrasonic receiving modules and a wireless communication module on the robot, the robot calculates a distance and angle of the robot relative to the charging mount according to a time difference between the time when ultrasonic signals are received, and completes automatic tracing of the robot in combination with a motion control system and a posture adjustment strategy to automatically charge the robot. The method and system according to the present disclosure have a low cost, are suitable for a complicated application environment, and improve intelligence of the robots.

### BRIEF DESCRIPTION OF THE DRAWINGS

FIG. 1 is a structural diagram of a system for automatically charging a robot according to the present disclosure;

FIG. 2 is a schematic modular diagram of a robot system according to the present disclosure;

FIG. 3 is a schematic modular diagram of a charging mount system according to the present disclosure;

FIG. 4 is a flowchart of a method for automatically charging a robot according to an embodiment of the present disclosure;

FIG. 5 is a control flowchart of the charging mount system according to the present disclosure;

FIG. 6 is a schematic diagram of triangle positioning calculation;

FIG. 7 is a schematic diagram illustrating wireless synchronization and ultrasonic ranging; and

FIG. 8 is schematic diagram illustrating an electrical principle of an ultrasonic transmitting module.

### DETAILED DESCRIPTION

Hereinafter a method and system for automatically charging a robot according to the present disclosure are described in retail with reference to the accompanying drawings.

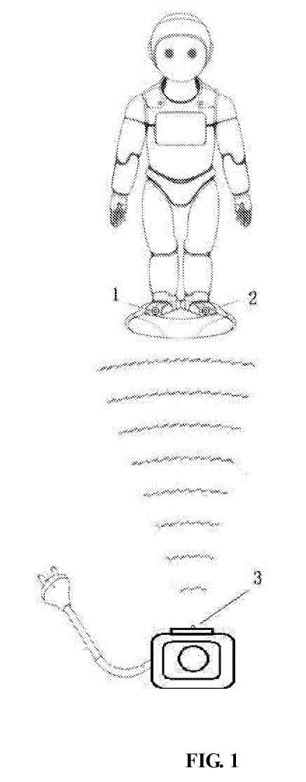

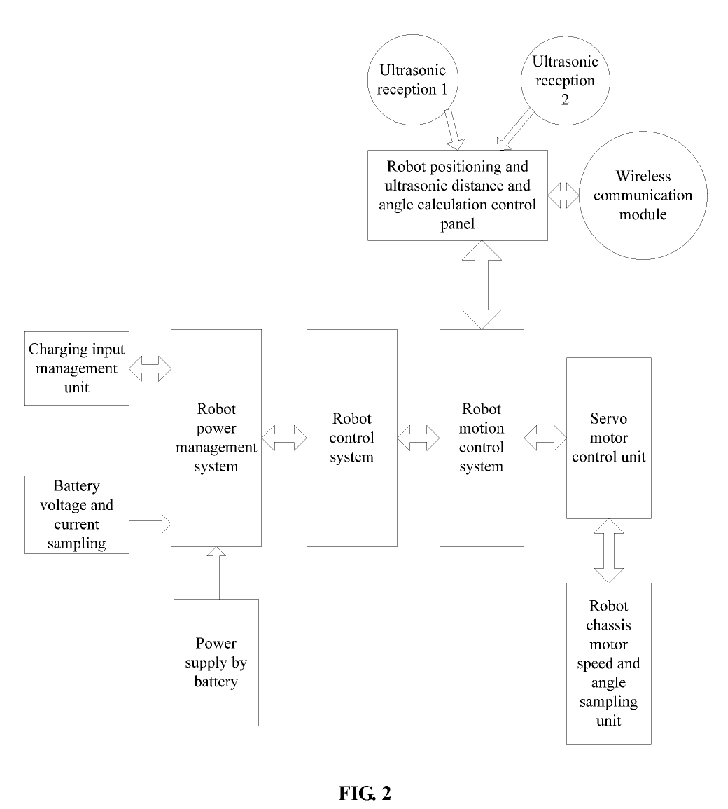

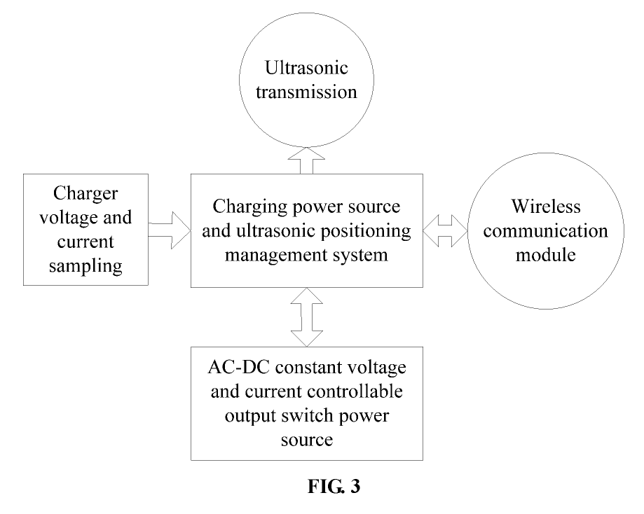

As illustrated in FIG. 1 to FIG. 3, a system for automatically charging a robot includes: a robot control system, a robot power management system, a robot motion control system, a robot positioning and ultrasonic distance and angle calculation control panel, a first ultrasonic receiving module 1, a second ultrasonic receiving module 2, and a charging power source and ultrasonic positioning management system, an ultrasonic transmitting module 3 and a wireless communication module that are configured on a charging mount. The system further includes: a charging management unit, a battery voltage and current sampling unit, a battery unit, a servo motor control unit, and a robot chassis speed and angle sampling unit.

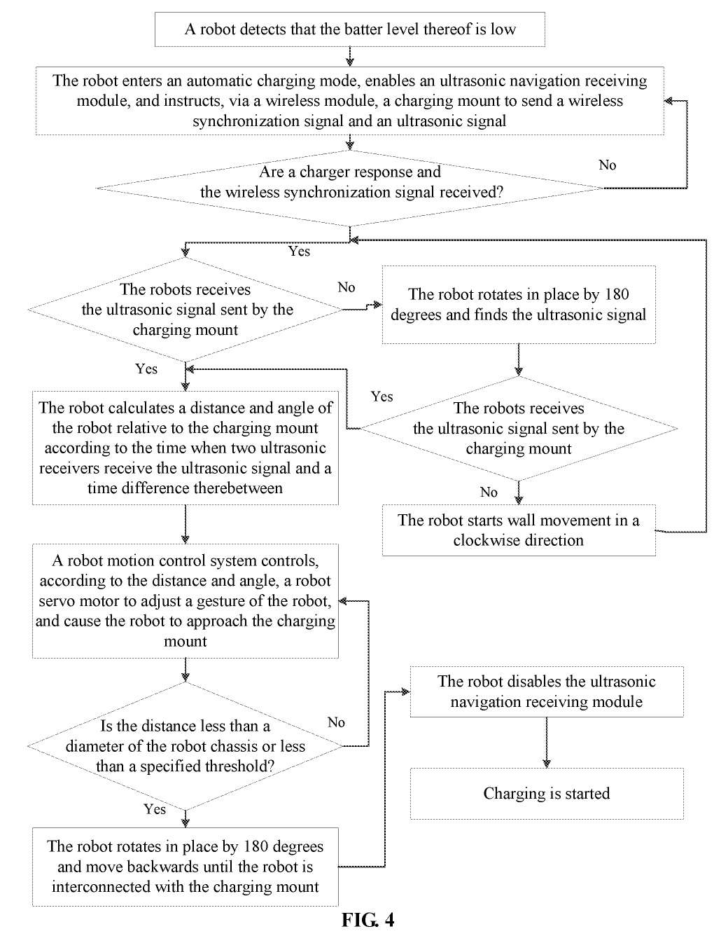

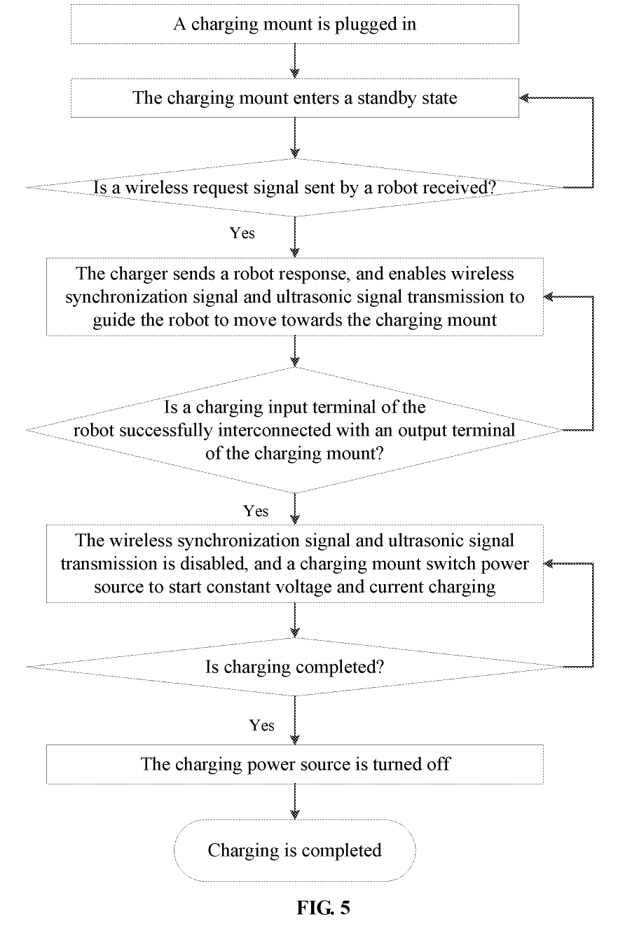

As illustrated in FIG. 4 and FIG. 5, a method for automatically charging a robot includes the following steps:

detecting, by the robot, a battery level, and communicating with a charging mount in a wireless manner if the battery level is low;

calculating, by the robot, a distance and angle of the robot relative to the charging mount according to a process that the robot communicates with the charging mount in the wireless manner;

controlling, by a motion control system of the robot, the robot to approach the charging mount according to the distance and angle; and

interconnecting, by the robot, with the charging mount for charging when the robot moves to the front of the charging mount or the distance and angle are less than predetermined thresholds.

Specifically, after a robot power management system detects that the battery level is low, that is, when it is detected that the battery is less than a predetermined threshold, the robot power management system deems that the battery is low, reports to a robot control system, and the robot control system enters an automatic charging mode, and sends an instruction to instruct a robot motion control system to get ready to enter an automatic charging tracing state. The robot motion control system enables an ultrasonic receiving control unit, and enables the charging mount to transmit an ultrasonic signal and a wireless synchronization signal in a wireless communication manner to guide the robot. The wireless communication includes an electromagnetic wave, infrared ray, laser, and the like wireless transceiving mode.

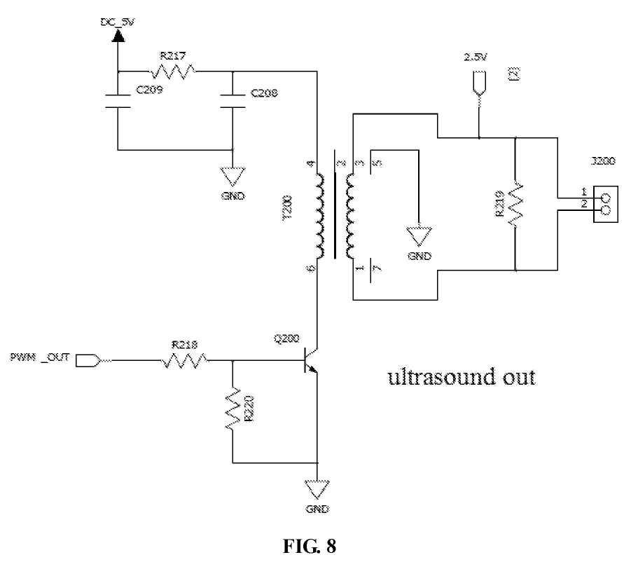

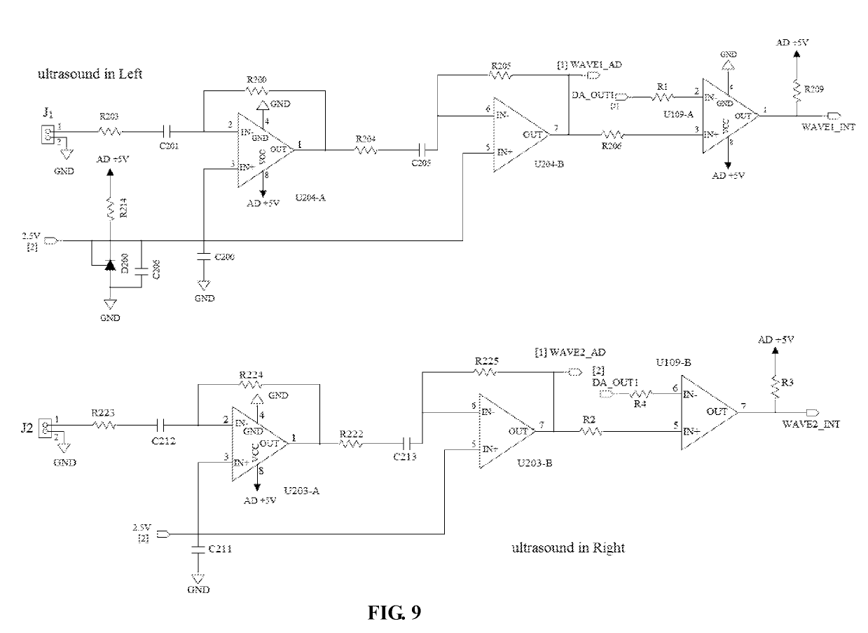

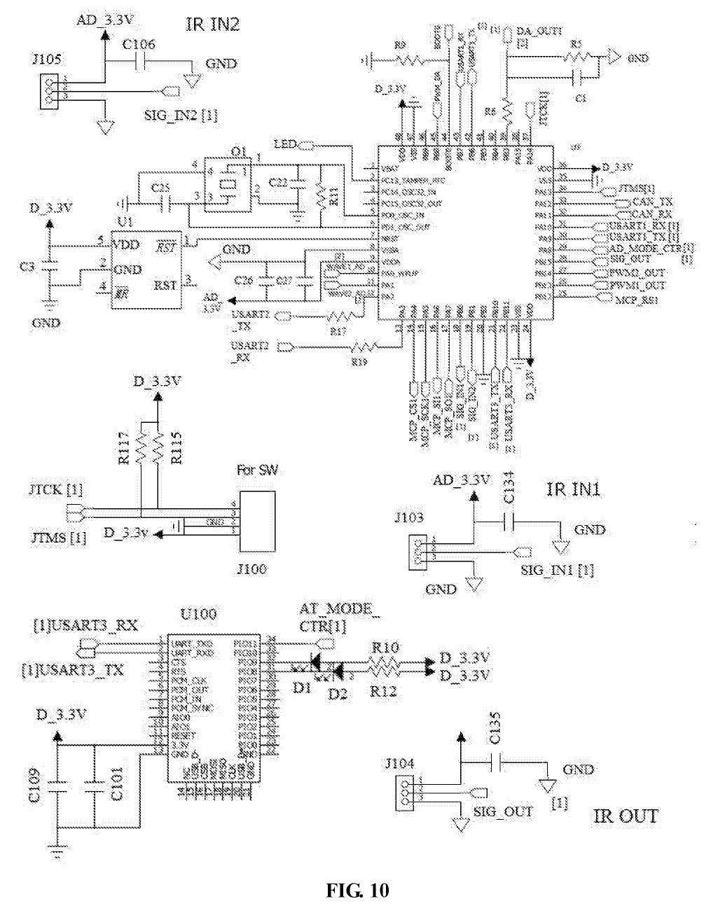

FIG. 8 illustrates an electrical principle of an ultrasonic transmitting module. The ultrasonic transmitting module 3 sends a fan-shaped acoustic wave, and starts to guide the robot to approach the charging mount.

After receiving an ultrasonic pulse signal, a robot calculates a distance and angle of the robot relative to a charging mount according to the time when the ultrasonic signal is received by a first ultrasonic receiving module 1, the time when the ultrasonic pulse signal is received by a second ultrasonic receiving module 2, and a time difference between the time when the ultrasonic signal is received by the first ultrasonic receiving module 1 and the time when the ultrasonic signal is received by the second ultrasonic receiving module 2.

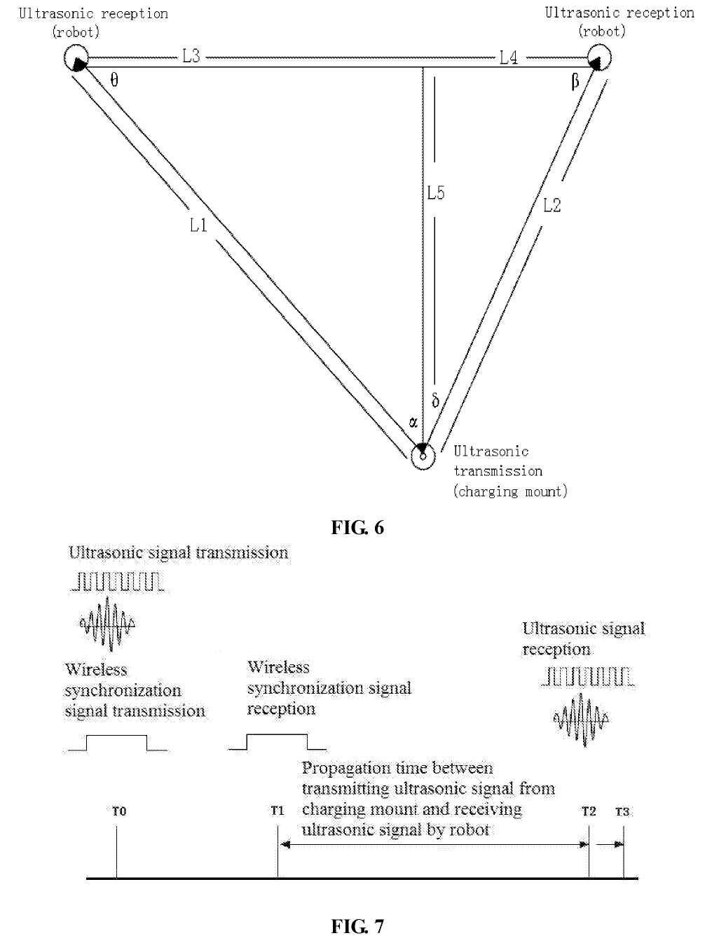

As illustrated in FIG. 6, since the propagation velocity of light is far greater than the propagation velocity of the ultrasonic wave in the air, at the time of T1, the robot firstly receives a wireless synchronization signal, and an ultrasonic receiving control unit records the time T1. At the time of T2 and T3, the left and right receivers of the robot respectively receive an ultrasonic pulse signal sent by the charging mount. Assume that the propagation velocity of the acoustic wave in the air under room temperatures is 340 m/s, a distance between the charging mount and one ultrasonic receiver and a distance between the charging mount and the other ultrasonic receiver are respectively L1=340*(T3−T1+T1−T0) and L2=340*(T2−T1+T1−T0). Since the propagation time T1−T0 of a wireless signal is too short and may be even ignored, the distance between the charging mount and one ultrasonic receiver and the distance between the charging mount and the other ultrasonic receiver may be respectively simplified to L1=340*(T3−T1) and L2=340*(T2−T1).

As such, L1 and L2 are calculated, and since the triangles L1 and L2 are known, L3+L4 is also fixed, a vertical distance L5 between the charging mount and the robot and an angle deviation (α−δ) of the charging mount relative to the robot may be calculated using the following formulae:

L2²=L1²+(L3+L4)²−2*L1*(L3+L4)*cos(θ)

cos(θ)=L3/L1

L1²=L5²+L3²

cos(α)=L5/L1

cos(δ)=L5/L2

In this way, a position of the robot may be precisely positioned, and the robot is navigated to go back to the charging mount for charging.

When the robot moves to the front of the charging mount or the distance is less than a predetermined threshold, the robot rotates in place by 180 degrees, and runs backwards to interconnect with the charging mount; when a robot power management system detects that a charging voltage is accessed, it is deemed that the robot has been reliably interconnected with the charging mount. In this case, the charging mount disables the wireless synchronization signal and the ultrasonic pulse signal, and the robot also disables an ultrasonic receiving signal; and when the charging is finished, the charging mount disables charging power output, and an entire automatic charging process is completed.

The present disclosure may be applied in various scenarios. Described above are merely preferred embodiments illustrating the present disclosure. It should be noted that persons of ordinary skill in the art would derive several improvements to the present disclosure without departing from the principle of the present disclosure, and these improvements shall be considered as falling within the protection scope of the present disclosure.

What is claimed is:

1. A method for automatically charging a robot, comprising the following steps:
detecting, by the robot, a battery level, and communicating with a charging mount in a wireless manner if the battery level is less than a predetermined threshold;
calculating, by the robot, a distance and angle of the robot relative to the charging mount according to a process that the robot communicates with the charging mount in the wireless manner;
controlling, by a motion control system of the robot, the robot to approach the charging mount according to the distance and angle; and
interconnecting, by the robot, with the charging mount for charging when the robot moves to the front of the charging mount or the distance and angle are less than predetermined thresholds.

2. The method for automatically charging a robot according to claim 1, wherein the process that the robot communicates with the charging mount in the wireless manner is implemented by:
receiving, by the robot, a wireless synchronization signal sent by a wireless communication module of the charging mount by using a wireless communication module configured on the robot; and
receiving, by the robot, an ultrasonic pulse signal sent by an ultrasonic transmitting module by using a first ultrasonic receiving module and a second ultrasonic receiving module that are configured on the robot;
wherein the wireless synchronization signal and the ultrasonic pulse signal are simultaneously sent.

3. The method for automatically charging a robot according to claim 2, wherein the calculating, by the robot, a distance and angle of the robot relative to the charging mount according to a process that the robot communicates with the charging mount in the wireless manner comprises:
calculating, by the robot, the distance and angle of the robot relative to the charging mount according to the time when the wireless synchronization signal is received by the robot, the time when the ultrasonic pulse signal is received by the first ultrasonic receiving module, the time when the ultrasonic pulse signal is received by the second ultrasonic receiving module, a time difference between the time when the wireless synchronization signal is received and the time when the ultrasonic pulse signal is received by the first ultrasonic receiving module, and a time difference between the time when the wireless synchronization signal is received and the time when the ultrasonic pulse signal is received by the second ultrasonic receiving module.

4. The method for automatically charging a robot according to claim 3, wherein the process of calculating, by the robot, a distance and angle of the robot relative to the charging mount specifically comprises:
calculating a distance between the first ultrasonic receiving module and the charging mount according to the time T1 when the wireless synchronization signal is received by the robot and the time T3 when the ultrasonic pulse signal is received by the first ultrasonic receiving module of the robot, L1 being calculated using formula L1=340*(T3−1);
calculating a distance between the second ultrasonic receiving module and the charging mount according to the time T1 when the wireless synchronization signal is received by the robot and the time T2 when the ultrasonic pulse signal is received by the second ultrasonic receiving module of the robot, L2 being calculated using formula L2=340*(T2−1); and
according to a distance L3+L4 between the first ultrasonic receiving module and the second ultrasonic receiving module, the distance L1 between the first ultrasonic receiving module and the charging mount and the distance L2 between the second ultrasonic receiving module and the charging mount, calculating a vertical distance L5 between the charging mount and the robot and an angle deviation (α−δ) of the charging mount relative to the robot using the following formula:
L2²=L1²+(L3+L4)²−2*L1*(L3+L4)*cos(θ)
cos(θ)=L3/L1
L1²=L5²+L3²
cos(α)=L5/L1
cos(δ)=L5/L2

5. The method for automatically charging a robot according to claim 2, wherein the receiving, by the robot, an ultrasonic pulse signal sent by an ultrasonic transmitting module by using a first ultrasonic receiving module and a second ultrasonic receiving module that are configured on the robot comprises:
upon receiving a response from the charging mount and the wireless synchronization signal, initially judging, by the robot, whether the ultrasonic pulse signal sent by the charging mount is received; and
if the ultrasonic pulse signal is not received, rotating in place, by the robot, by 180 degrees to find the ultrasonic pulse signal.

6. The method for automatically charging a robot according to claim 5, wherein the receiving, by the robot, an ultrasonic pulse signal sent by an ultrasonic transmitting module by using a first ultrasonic receiving module and a second ultrasonic receiving module that are configured on the robot further comprises:
upon rotating in place by 180 degrees, judging again, by the robot, whether the ultrasonic pulse signal sent by the charging mount is received; and
if the ultrasonic pulse signal is still not received after the robot rotates in place by 180 degrees, starting wall movement in a clockwise direction by the robot and returning to the initially judging whether the ultrasonic pulse signal sent by the charging mount is received.

7. A system for automatically charging a robot, comprising: a robot and a charging mount; wherein
the robot comprises:
a robot control system, a robot power management system, a robot motion control system, a robot positioning and ultrasonic distance and angle calculation control panel, a first ultrasonic receiving module and a second ultrasonic receiving module; and
the charging mount comprises:
a power source and ultrasonic positioning management system, an ultrasonic transmitting module and a wireless communication module.

8. The system for automatically charging a robot according to claim 7, wherein the robot further comprises: a charging management unit, a battery voltage and current sampling unit and a battery unit.

9. The system for automatically charging a robot according to claim 7, wherein the robot further comprises: a servo motor control unit and a robot chassis motor speed and angle sampling unit.
